(19) United States
(12) Patent Application Publication
(10) Pub. No.: US 2015/0146875 A1
(43) Pub. Date: May 28, 2015

(54) DETERMINING THE TEMPERATURE OF A LOUDSPEAKER VOICE COIL

(71) Applicant: NXP B.V., Eindhoven (NL)

(72) Inventor: Temujin Gautama, Leuven (BE)

(21) Appl. No.: 14/520,090

(22) Filed: Oct. 21, 2014

(30) Foreign Application Priority Data
Nov. 28, 2013 (EP) 13194907.5

(51) Int. Cl. H04R 29/00

(52) U.S. Cl. CPC H04R 29/001
USPC 381/58

(57) ABSTRACT

A method for determining the temperature of a loudspeaker voice coil comprising the steps of:
determining the impedance value of a loudspeaker voice coil at a predetermined evaluation frequency which is greater than 16 kHz and/or in the ultrasonic frequency range; and
determining a measure of the temperature of the loudspeaker voice coil based on the impedance value.

This invention relates to loudspeakers, and particularly, but not exclusively to determining the temperature of a loudspeaker voice coil.

Loudspeakers generally comprise a diaphragm (or cone), connected to a rigid frame, via a flexible suspension that constrains a voice coil to move axially through a cylindrical magnetic gap. When an electrical signal is applied to the voice coil, a magnetic field is created by the electric current in the voice coil, making it a variable electromagnet. The coil and the driver's magnetic system interact, generating a mechanical force that causes the coil (and thus, the attached diaphragm) to move back and forth, thereby reproducing sound under the control of the applied electrical signal coming from the amplifier.

Loudspeakers are devices that convert electrical energy into (desired) acoustical and (undesired) thermal energy. Much of the electrical power that is applied to the loudspeaker results in heat dissipation, which causes many of the common loudspeaker defects. It is therefore beneficial to be able to monitor the temperature of the loudspeaker voice coil.

According to a first aspect of the invention, there is provided a method for determining the temperature of a loudspeaker voice coil comprising the steps of:
determining the impedance value of a loudspeaker voice coil at a predetermined evaluation frequency greater than 16 kHz; and
determining a measure of the temperature of the loudspeaker voice coil based on the impedance value.

According to a second aspect of the invention, there is provided a method for determining the temperature of a loudspeaker voice coil comprising the steps of:
determining the impedance value of a loudspeaker voice coil at a predetermined ultrasonic frequency; and
determining a measure of the temperature of the loudspeaker voice coil based on the impedance value.

It will be appreciated that the evaluation frequency may be greater than 16 kHz and ultrasonic. That is, the predetermined evaluation frequency that is greater than 16 kHz may be in the ultrasonic range.

The evaluation frequency may be equal to or greater than 20 kHz. It will be appreciated that the ultrasonic range may comprise frequencies greater than 20 kHz.

The method may comprise providing an input signal to the loudspeaker, the input signal comprising: an evaluation signal at the evaluation frequency; and an audio signal.

The impedance may be determined by measuring the frequency components of the voltage and current signal at that evaluation frequency and computing the ratio of the voltage to current. The frequency components of the voltage and the current signal may be complex-valued. The ratio may also be complex-valued.

The complex-valued frequency components may be determined using Fourier transform methods.

The method may comprise: adjusting the input signal to compensate for temperature changes in the voice coil.

The method may comprise: adjusting the input signal to inhibit increases in the voice coil temperature. The method may comprise: adjusting the input signal to prevent the voice coil temperature increasing above a predetermined threshold. For example the adjustments to the input signal may include adjusting the gain, filtering or dynamic range control.

The method may comprise:
determining the resistive part of the loudspeaker voice coil impedance at the evaluation frequency based on the impedance determination; and
determining a measure of the temperature of the loudspeaker voice coil based on the resistive part of the impedance.

The temperature may be determined using a first-order or second-order polynomial relationship between the temperature and the resistive part of the loudspeaker voice coil impedance at the evaluation frequency.

According to a third aspect of the invention, there is provided an apparatus comprising:
an impedance determining module configured to determine the impedance value of a loudspeaker voice coil at a predetermined evaluation frequency greater than 16 kHz; and
a temperature determining module configured to determine a measure of the temperature of the loudspeaker voice coil based on the impedance value.

According to a fourth aspect of the invention, there is provided an apparatus comprising:
an impedance determining module configured to determine the impedance value of a loudspeaker voice coil at a predetermined ultrasonic frequency; and
a temperature determining module configured to determine a measure of the temperature of the loudspeaker voice coil based on the impedance value.

The temperature determining module may comprise a processor.

The impedance determining module may comprise:
a current sensing means to measure the current passing through the loudspeaker voice coil;
a voltage sensing means to measure the voltage across the loudspeaker voice coil; and
a processor configured to determine the complex-valued frequency components of the voltage and the current at the evaluation frequency and determine the ratio of the voltage to the current components.

The impedance determining module may consist of a voltage sensing means (such as a voltage sense amplifier), a current sensing means (such as a current sense amplifier the output voltage of which may be proportional to the current; a current sense or shunt resistance in series with the load may be used to convert the load current to a small voltage, which is amplified by the current sense amplifier) and a means for computing the complex-valued frequency components of the voltage, V(ω) and current, I(ω), and computing the impedance according to

$$Z ( ω ) = \frac{V ( ω )}{I ( ω )}$$

(such as a processor and analog-to-digital converters for converting the voltage and current signals to the digital domain).

The apparatus may comprise a signal generator configured to generate the predetermined signal.

According to a fifth aspect of the invention, there is provided a computer program comprising computer program code configured to:
determine the impedance value of a loudspeaker voice coil at a predetermined evaluation frequency greater than 16 kHz; and
determine a measure of the temperature of the loudspeaker voice coil based on the impedance value.

According to a sixth aspect of the invention, there is provided a computer program comprising computer program code configured to:
determine the impedance value of a loudspeaker voice coil at a predetermined ultrasonic frequency; and
determine a measure of the temperature of the loudspeaker voice coil based on the impedance value.

Embodiments will now be described by way of non-limiting examples with reference to the accompanying figures, in which:

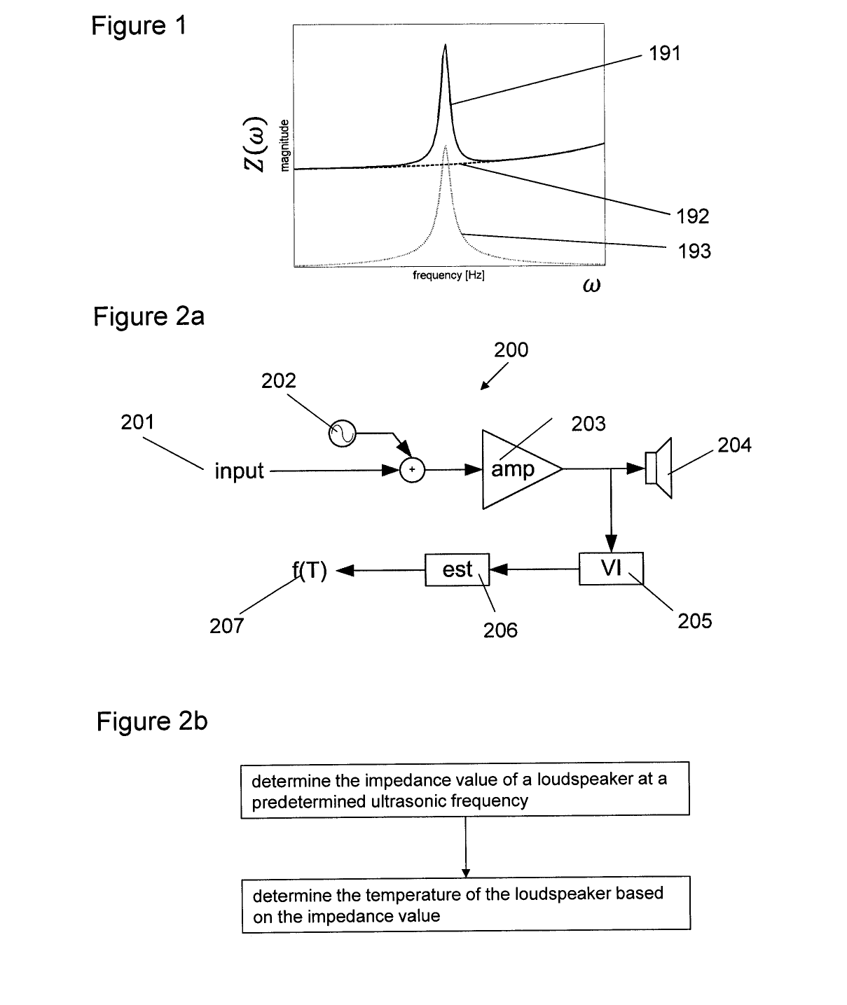

FIG. 1 illustrates the impedance function of a loudspeaker; and

FIGS. 2a-2b illustrate an apparatus and method according to an embodiment of the invention configured to determine a measure of the temperature of a loudspeaker voice coil;

Loudspeakers are devices to convert electrical energy into acoustical energy. However, a portion of the electrical power that is applied to the loudspeaker may result in heat being generated. This heat may cause loudspeaker defects. In order to prevent thermal damage (whether permanent or non-permanent), it may be desirable to condition the input signal in such a way that the loudspeaker voice coil temperature does not exceed a certain limit. Alternatively, it may be desirable to compensate for acoustic effects generated by changes in the temperature of the loudspeaker voice coil.

The invention provides a method to determine a measure of the voice coil temperature, based on the impedance of the voice coil. In particular, the method involves providing an evaluation signal comprising a signal having a frequency which is in the ultrasonic range and/or greater than 16 kHz.

The loudspeaker impedance, Z(ω), is a complex-valued function of frequency, ω, and can be computed as the ratio between the voltage across the voice coil, V(ω), and the current flowing into the voice coil, I(ω), at the particular frequency:

$$Z ( ω ) = \frac{V ( ω )}{I ( ω )}$$

FIG. 1 shows the magnitude plot of a typical loudspeaker impedance function, which shows a resonance peak. The total impedance 191 comprises the sum of the motional impedance 193 (dotted curve) and the blocked electrical impedance 192 (dashed curve). The blocked electrical impedance 192, Zₑ(ω), in turn, is made of the DC resistance of the voice coil, Rₑ, and the residual impedance that represents the effect of the lossy inductance, Z_{L,e}(ω).

In the context of voice coil temperature estimation, the DC resistance of the loudspeaker, Rₑ, is an important property because the value of Rₑ is related to the temperature T. This relationship can be modelled by a first-order or second-order polynomial:

Rₑ(T)=Rₑ(T₀){1+α₀(T−T₀)+β₀(T−T₀)²},

where Rₑ(T₀) is the value of the DC resistance at reference temperature T₀, and α₀ And β₀ are the first-order and second-order coefficients of the polynomial (for a first-order polynomial, β₀ is zero). The coefficients may depend on the voice-coil material.

If the evaluation frequency were to be chosen in the low-frequency region, e.g., well below the resonance frequency of the loudspeaker (say, around 50 Hz for a micro-speaker), the added tone may still be audible under certain conditions (e.g., if an acoustical vent is present in the loudspeaker enclosure, with a frequency close to the evaluation frequency). Furthermore, for all evaluation frequencies below the loudspeaker resonance frequency, the diaphragm displacement is not negligible, and therefore needs to be taken into account. This results in a displacement headroom that needs to be reserved for the evaluation tone.

The present embodiment of the invention uses an evaluation frequency that is well above the loudspeaker resonance frequency, preferably on the border or beyond the audio frequency band (20 kHz or higher). It will be appreciated that other embodiments may use frequencies bordering on the audible frequency range (e.g. greater than 16 kHz). In these frequency regions, the diaphragm displacement is nearly zero, so no displacement headroom needs to be reserved for the evaluation tone. Furthermore, for low frequencies, the amplifier noise is expected to increase. Higher evaluation frequencies may also mean that the period of the tone can be much shorter, which may allow the temperature estimates to be available faster, allowing for a finer temporal resolution.

Embodiments of the present invention provide an apparatus, computer program and method for estimating the temperature of a loudspeaker voice coil using an evaluation signal (e.g. a sine wave) at an ultrasonic evaluation frequency. The frequency of this evaluation signal is configured to be well above the resonance frequency of the loudspeaker, preferably at the border of, or outside the audio band (in the ultrasonic frequency region). A component of the complex-valued electrical impedance estimate at this frequency can be used as a measure related to the temperature of the loudspeaker voice coil.

An apparatus 200 according to an embodiment of the invention for the voice coil temperature estimation is shown in FIG. 2a. In this case, the apparatus 200 comprises: a means for generating the ultrasound evaluation frequency 202, which in this case is a signal generator; a means for determining the impedance of the loudspeaker voice coil comprising means 205 for monitoring the voltage across the voice coil and the current flowing into the voice coil; and a means 206 for computing the complex-valued frequency components of voltage and current at the evaluation frequency and estimating the voice coil temperature, or a measure related to it, from the complex-valued frequency components. In this case, the apparatus also comprises an amplifier 203; and audio input 201. The apparatus is connected to a loudspeaker 204.

In this case, the signal generator 202 is configured to generate a sine wave at a predetermined ultrasonic evaluation frequency (e.g. 22 kHz) which is then added to the audio input 201 (e.g. the music recording which is being played). In this way, the temperature may be determined during normal use of the loudspeaker 204, rather than, for example, requiring a dedicated temperature measuring phase.

The resulting signal is sent to the loudspeaker 204 via an amplifier 203. The voltage across and the current flowing into the loudspeaker voice coil are sensed using the current and voltage sensing means 205 and form the input to the estimation module 206. The voltage sensing means in this case comprises a voltage sense amplifier; and the current sensing means comprises a current sense amplifier.

The temperature determining module 206, which in this case comprises a processor, extracts the complex-valued frequency components at the evaluation frequency (e.g., using a DFT), and computes the complex-valued ratio,

$$Z ( {ω}_{1} ) = \frac{V ( {ω}_{1} )}{I ( {ω}_{1} )} ,$$

thereby giving the impedance, where V(ω₁) and I(ω₁) are the complex-valued frequency components of the voltage across and the current flowing into the loudspeaker voice coil at the evaluation frequency ω₁. In this case, the evaluation frequency is in the ultrasonic range. For other embodiments, the evaluation frequency may be greater than 16 kHz. These frequency components can be estimated using methods known in the literature, such as by using discrete Fourier transform (DFT).

In this case, the ultrasonic evaluation frequency is configured to be high enough so that the impedance value Z(ω₁) is dominated by the blocked electrical impedance, and the motional impedance should be sufficiently small. That is, the blocked electrical impedance should be significantly larger than the motional impedance component. Therefore,

Z(ω₁)≈Zₑ(ω₁)=Rₑ(ω₁)+jZ_{L,e}(ω₁)

and the real component of Z(ω₁) (the resistive part of the impedance at the evaluation frequency) is related to the temperature as described above.

From this complex-valued ratio, the temperature determining module is configured to determine a measure of the temperature using the real part of this ratio. The output of the temperature determining module 206 is a measure of temperature 207. The measure of temperature may be, for example a value in ° C. For other embodiments, the real part of the ratio at the evaluation frequency may itself be considered a measure of temperature.

In this embodiment, the apparatus is configured to determine the temperature in ° C. using the polynomial equation described above. In this case, the polynomial coefficients α₀, β₀ necessary to relate the resistive part of the impedance at the evaluation frequency to the temperature are known (e.g. as they are related to the material of the voice coil and the resistive part would consist only of the DC resistance). It will be appreciated that, in other embodiments, the relationship between the temperature and the resistive part of the impedance at the evaluation frequency (e.g. the polynomial coefficients α₀, β₀) may be determined in a separate calibration procedure, e.g., by measuring the Rₑ at the reference temperature, T₀, and one or several other known temperatures.

The method used by the apparatus of FIG. 2a to determine a measure of the temperature of the voice coil is shown in FIG. 2b.

Embodiments of the invention may be used as part of a smart amplifier that drives a loudspeaker. The estimated temperature can be used to ensure that the loudspeaker does not go beyond a user-defined temperature threshold, thus protecting the loudspeaker against thermal damage. This can be necessary in mobile phones (e.g. smart phones), but also in larger amplifiers for automotive or home applications.

Other embodiments of the invention may use the measure of temperature determined to compensate for audio effects caused by changes in the temperature of the voice coil.

Any components that are described or shown herein as being “coupled” or “connected” could be directly or indirectly coupled or connected. That is, one or more components could be located between two components that are said to be coupled or connected whilst still enabling the required functionality to be achieved.

1. A method for determining the temperature of a loudspeaker voice coil comprising the steps of:
determining the impedance value of a loudspeaker voice coil at a predetermined evaluation frequency greater than 16 kHz; and
determining a measure of the temperature of the loudspeaker voice coil based on the impedance value.

2. The method of claim 1, wherein the predetermined evaluation frequency is in the ultrasonic range.

3. A method for determining the temperature of a loudspeaker voice coil comprising the steps of:
determining the impedance value of a loudspeaker voice coil at a predetermined ultrasonic evaluation frequency; and
determining a measure of the temperature of the loudspeaker voice coil based on the impedance value.

4. The method of claim 3, wherein the evaluation frequency is equal to or greater than 20 kHz.

5. The method of claim 3, wherein the method comprises providing an input signal to the loudspeaker, the input signal comprising: an evaluation signal at the evaluation frequency; and an audio signal.

6. The method of claim 3, wherein the impedance is determined by measuring the frequency components of the voltage and current signal at the evaluation frequency and computing the ratio of the voltage to current.

7. The method of claim 3, wherein the method comprises:
adjusting the input signal to inhibit increases in the voice coil temperature.

8. The method of claim 3, wherein the method comprises:
determining the resistive part of the loudspeaker voice coil impedance at the evaluation frequency, based on the impedance determination; and
determining a measure of the temperature of the loudspeaker voice coil based on the resistive part of the impedance.

9. The method of claim 8, wherein the measure of the temperature is determined using a first-order or second-order polynomial relationship between the temperature and the resistive part of the loudspeaker voice coil impedance at the evaluation frequency.

10. An apparatus comprising:
an impedance determining module configured to determine the impedance value of a loudspeaker voice coil at a predetermined evaluation frequency greater than 16 kHz; and
a temperature determining module configured to determine a measure of the temperature of the loudspeaker voice coil based on the impedance value.

11. An apparatus comprising:
an impedance determining module configured to determine the impedance value of a loudspeaker voice coil at a predetermined ultrasonic frequency; and
a temperature determining module configured to determine a measure of the temperature of the loudspeaker voice coil based on the impedance value.

12. The apparatus of claim 10, wherein the temperature determining module comprises a processor.

13. The apparatus of claim 10, wherein the impedance determining module comprises:
current sensing means to measure the current passing through the loudspeaker voice coil;
a voltage sensing means to measure the voltage across the loudspeaker voice coil; and
a processor configured to compute the frequency components of the voltage and current at the evaluation frequency and determine the ratio of the voltage to the current components.

14. A computer program comprising computer program code configured to:
determine the impedance value of a loudspeaker voice coil at a predetermined evaluation frequency greater than 16 kHz; and
determine a measure of the temperature of the loudspeaker voice coil based on the impedance value.

15. A computer program comprising computer program code configured to:
determine the impedance value of a loudspeaker voice coil at a predetermined ultrasonic frequency; and
determine a measure of the temperature of the loudspeaker voice coil based on the impedance value.
